(19) United States
(12) Patent Application Publication
(10) Pub. No.: US 2019/0147687 A1
(43) Pub. Date: May 16, 2019

(54) HEALTHY PRODUCT VENDING SYSTEMS AND METHODS

(71) Applicant: Vijay Meduri, Saratoga, CA (US)

(72) Inventor: Vijay Meduri, Saratoga, CA (US)

(21) Appl. No.: 15/814,395

(22) Filed: Nov. 16, 2017

(51) Int. Cl. G07F 11/42

(52) U.S. Cl. CPC G07F 11/42

(57) ABSTRACT

Systems and methods are disclosed for dispensing product by inserting a product into a container fitting dimensions of vending machine cans; removing air from the container and sealing the container; placing the container in a vertical drop column sized for the cans; and upon order, delivering the container with the product into a receptacle.

### BACKGROUND

The present invention relates to sales of products using vending machines.

Soft drinks are the beverage of choice for millions of Americans, but sugary drinks increase the risk of type 2 diabetes, heart disease, and other chronic conditions.

People who consume sugary drinks regularly—1 to 2 cans a day or more—have a 26% greater risk of developing type 2 diabetes than people who rarely have such drinks. A study that followed 40,000 men for two decades found that those who averaged one can of a sugary beverage per day had a 20% higher risk of having a heart attack or dying from a heart attack than men who rarely consumed sugary drinks. (47) A related study in women found a similar sugary beverage—heart disease link. A 22-year-long study of 80,000 women found that those who consumed a can a day of sugary drink had a 75% higher risk of gout than women who rarely had such drinks. (49) Researchers found a similarly-elevated risk in men.

Dr. Frank Hu, Professor of Nutrition and Epidemiology at Harvard School of Public Health, recently made a strong case that there is sufficient scientific evidence that decreasing sugar-sweetened beverage consumption will reduce the prevalence of obesity and obesity-related diseases.

However, present day vending machines typically dispense only soda can or sugary beverage. Thus, consumers need alternatives in vending machines to stay healthy.

### SUMMARY

Systems and methods are disclosed for dispensing product by inserting a product into a container fitting dimensions of vending machine cans and replacing sugary beverage content with healthier alternatives; in some cases removing air from the container and sealing the container; placing the container in a vertical drop column sized for the cans; and upon order, delivering the container with the product into a receptacle. The form factor, weight and product clearances of the new containers are calibrated to work under different temperature and environmental conditions that the vending machines operate in.

Various other aspects of the present invention are described and claimed herein.

Advantages of the system may include one or more of the following. The system provides healthy alternatives to sugary drinks dispensed from vending machines. The system is convenient and easy to use. Its compatibility with can dispensing vending machines makes the delivery of healthy alternatives to sugared carbonated drinks accessible to anyone worldwide. The containers are environmentally sustainable and recyclable. The system is compatible with existing vending machines and thus is easy to distribute and deploy.

Other advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWING

The above and other objects, features and advantages of the present invention will become more readily apparent from the following description, reference being made to the accompanying drawing in which:

FIG. 1A-1B are a perspective view of vending machine 100.

FIG. 1C shows an exemplary vertical drop column for a container of healthy product.

FIG. 1D shows an exemplary container of healthy food or snacks delivered in machine of FIG. 1A-1B.

FIG. 2 is a schematic block diagram of vending machine 100.

FIG. 3 is a schematic block diagram of the processing of the products in the container and subsequent dispensing in the vending machine 100.

### DETAILED DESCRIPTION

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

Many companies have implemented, or are in the process of implementing, Corporate Wellness Programs as a means to help lower rising healthcare costs and promote a healthier, more productive work force. Eating a healthy, balanced diet has many benefits for the overall health of your employees including increased energy and work productivity—even fewer sick days. A healthy diet can also help to prevent health conditions such as heart disease, high blood pressure and Type 2 diabetes.

The present system provides healthy altrenatives to sugared soft drink available from vending machines providing delicious items that can be:

Organic

Low-calorie

Low-fat

Kosher

Gluten-free

Low-carb

All natural

Various disclosed embodiments of the present invention permit the healthy products to be dispensed through standard soft drink vending machine.

Various embodiments of the present invention provide a method and apparatus to dispense healthy products such as vegetables and fruits in the standard vending machine for soda.

Many additional aspects are disclosed herein. Various products are disclosed for performing the steps of the respective methods disclosed herein.

Other features, advantages and embodiments are readily apparent from the detailed description when taken in connection with the accompanying drawings.

Apparatus Architecture

An embodiment of the method and system of the present invention will now be discussed with reference to the figures.

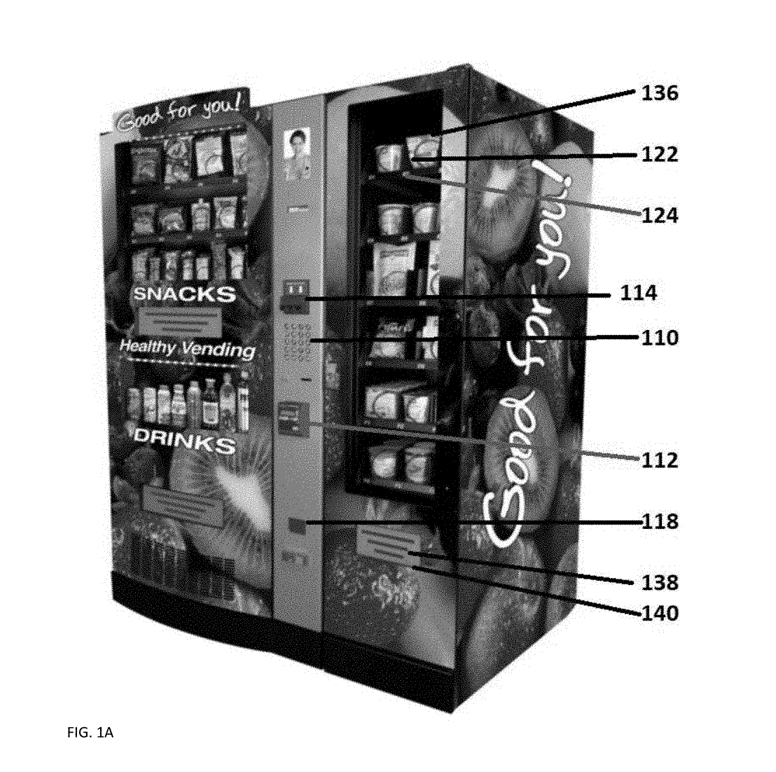

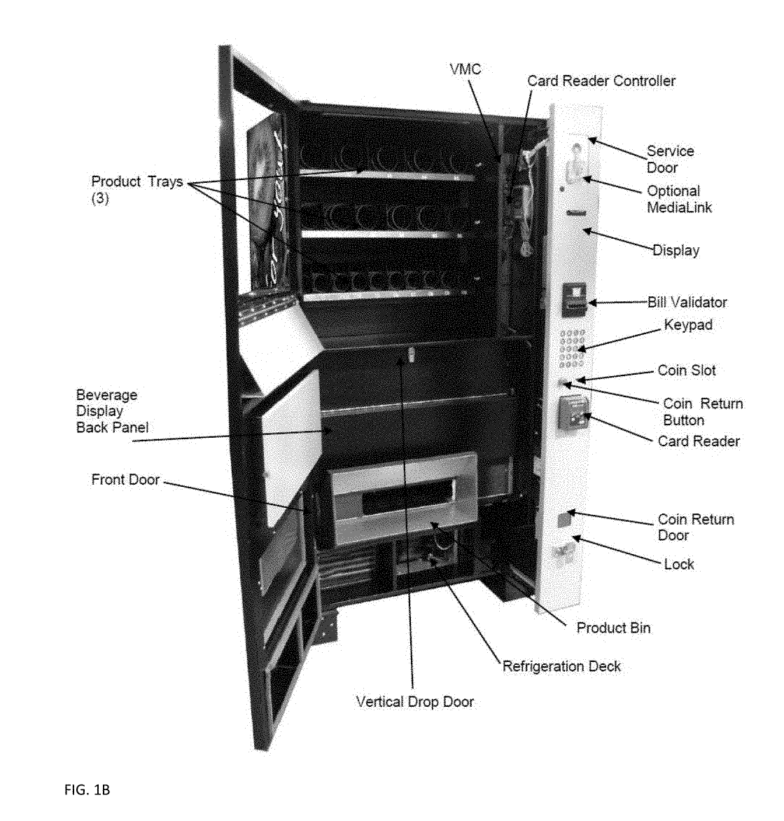

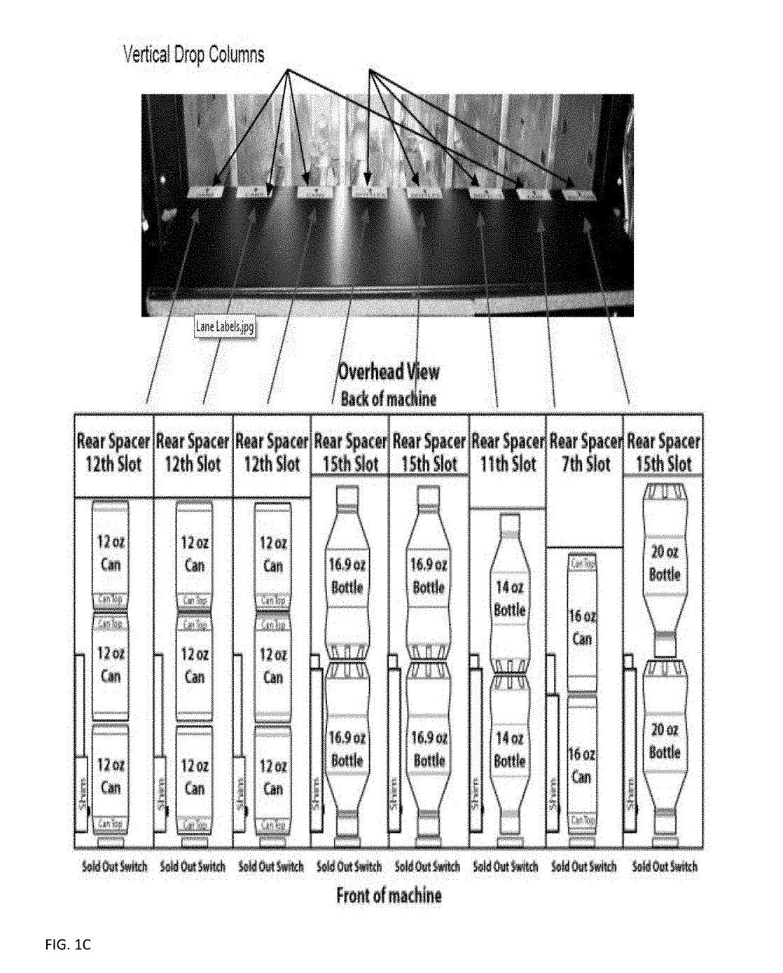

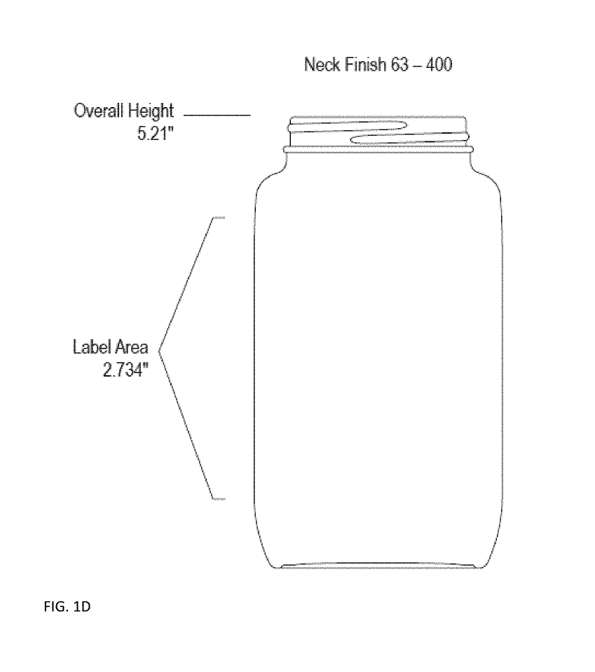

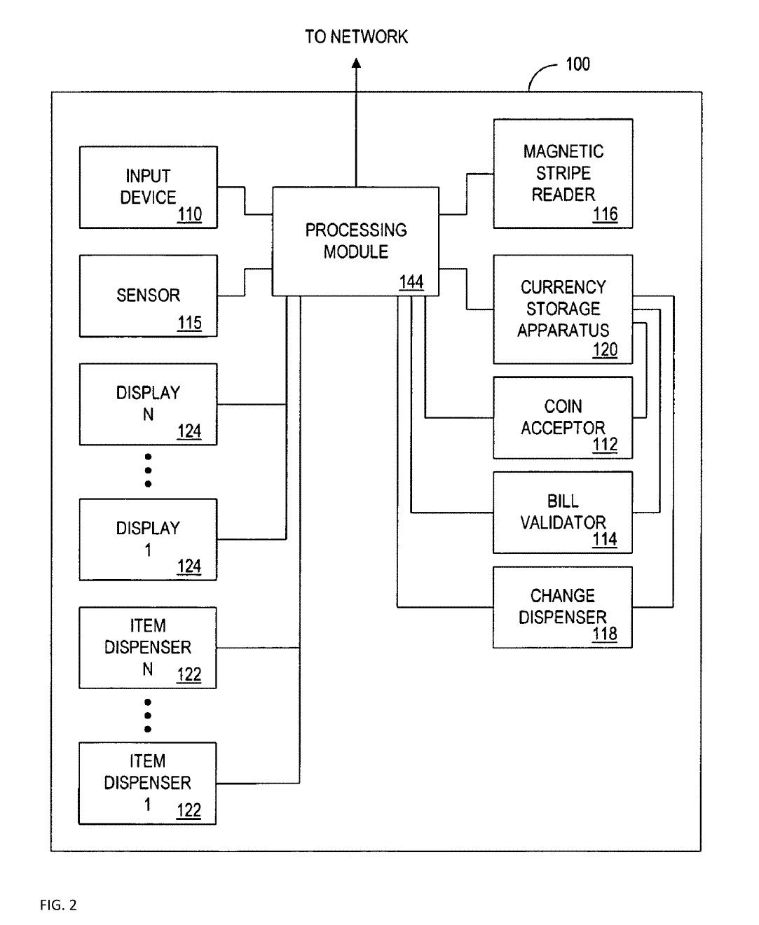

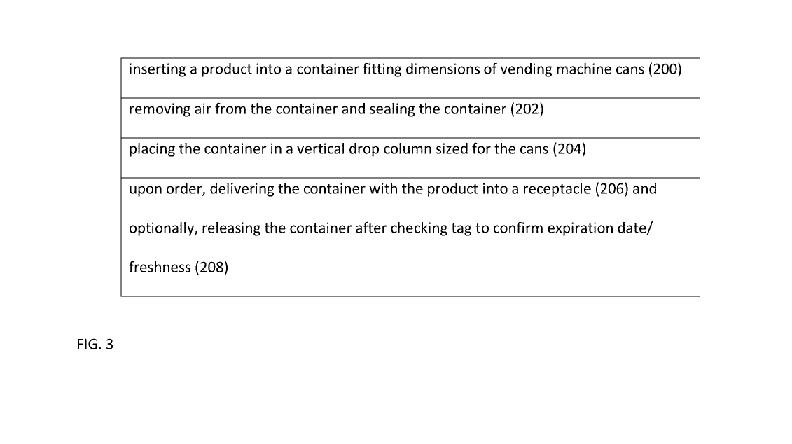

FIGS. 1A/1B-3 illustrate the components of one exemplary vending machine 100 including the features of the present invention. Although specific exemplary vending machine 100 is referred to throughout the detailed description, the present invention is directed to any automatic sales machine that allows payment to be exchanged for goods. Payment can be presented through a variety of media including, but not limited to, coins, bills and other currencies, magnetic stripe cards and smart cards (whether pre-paid or linked to an account), and identification codes (e.g., as provided through a keypad, provided via an RFID transmitter and receiver). FIG. 1A-1B are a perspective view of vending machine 100; FIG. 1C shows an exemplary vertical drop column for a container of healthy product, while FIG. 1D shows an exemplary container of healthy food or snacks delivered in machine 100. FIG. 2 is a schematic block diagram of vending machine 100; and FIG. 3 is a schematic block diagram of the processing module of vending machine 100.

The vending machine 100 may include many commercially-available casings/cabinets. For example, in snack machine embodiments, a suitable machine casing may include the Model HY900 from Seaga® of Freeport, Ill. The HY900 stands at 72″ height and 36″deep and 28.5″ depth. Other vending machines include the 129 SnackShop™ manufactured by Automatic Products International, Ltd.™ of Saint Paul, Minn., which stands at 72″/1829 mm wide, has a width of 38⅞″/988 mm, and a depth of 35″/889 mm. Other suitable snack machine casings include the A La Carte™ machine from Automatic Products™, and the GPL SnackVendor™ model #159 from Crane Merchandising Systems/Crane Co.™ of Stamford, Conn.

In beverage machine embodiments, machine cabinets commercially available from Dixie Narco™, Inc. of Williston, S. C. may be employed. Beverage machine cabinets may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co.™. Further details concerning the suitability of machine casing/cabinetry are well known in the art.

As shown, vending machine 100 may include one or more input devices 110 for receiving input from a customer indicating a product selection. Input device 110 may also be used for receiving input from an operator during stocking or maintenance of vending machine 100. Although input device 110, as illustrated, includes a set of alpha-numeric keys for providing input to vending machine 100, input device could include one or more of a selector dial, a set of buttons associated with a respective set of item dispensers, a motion sensor, a barcode reader, a Dual-Tone Multi-Frequency (DTMF) receiver/decoder, a wireless device (e.g. a cellular telephone or wireless Personal Digital Assistant), cameras, such as digital video and/or digital still photographic cameras, a voice recognition module, a fingerprint reader, a topical facial pattern scanner/reader, an iris or retinal scanner, a microphone, an infrared receiver, any device capable of receiving a command from a user and transmitting the command to a processor, and/or any conventional input device commonly employed by a vending machine designer. Further, vending machine 100 may include more than one input device 110. For example, vending machine 100 may include an exterior input device 110 for receiving customer input and an interior input device (not shown) for receiving operator input. In the illustrated embodiment, input device 110 receives input data from both operators and customers.

The vending machine 100 may further comprise one or more output devices. An output device may be operable to receive input from a customer, operator, or other person. Also, an output device may be operable to output product and/or other information to a customer or operator.

An output device may comprise, for example, one or more Liquid Crystal Displays (LCDs). An output device may comprise one or more Light Emitting Diodes (LEDs) displays (e.g., several alphanumeric LEDs on the shelves of a vending machine, each LED being associated with a row of product inventory). The price display 124 may provide the functionality of such LEDs.

In one embodiment, an LED display screen may be mounted to a vending machine (e.g., attached thereto, such as via bolts or other mounting hardware). Such a mounted LED display screen and may be used to communicate messages (described herein) to customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g., red, yellow, green).

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. Further, a printer may be capable of thermal line printing of various alphanumeric and graphical symbols in various font sizes (e.g. raging from 9 to 24 point) on various types of paper. Additionally, such a printer may communicate with a processor (described herein) via an RS232/IEEE 12834 and/or bi-directional parallel connection. Such a printer may further comprise a 4 KB data buffer.

Additionally, in some embodiments, an output device comprises an audio module, such as an audio speaker, that outputs information to customers audibly. Speakers may comprise conventional speakers or modern hypersonic speakers.

Many combinations of input and output devices may be employed in accordance with embodiments of the present invention. For example, in embodiments which include touch screens, input and output functionality may be provided by a single device. As described, in some embodiments, a touch-sensitive screen may be employed to perform both input and output functions. Suitable, commercially available touch screens for use in accordance with the present invention are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in2 (15,500 touchpoints/cm2) for a 13-inch touch screen. For such touch screens, the touch activation force required to trigger an input signal to the processor (described herein) via the touch screen is typically 2 to 4 ounces (57 to 113 g). Additionally, touch screens for use in accordance with embodiments of the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known in the art.

As shown, vending machine 100 may include a sensor 115 for sensing surrounding environmental conditions. In one embodiment, sensor 115 comprises a conventional temperature sensor configured to sense the local outdoor temperature or the external environmental temperature surrounding vending machine 100. Sensor 115 could include a receiver for receiving a local temperature from a weather service. In another embodiment, the sensor 115 may comprise a motion detector (e.g., which generates a signal when a physical body in proximity to the sensor moves above a certain rate of speed). Such input from a motion detector would be useful, e.g., in basing one or more price changes on “foot traffic” (people detected or estimated to be in the area of the vending machine) or changes in foot traffic (e.g., increases or decreases in the number of people per time detected or estimated to be in the area of the vending machine). For example, the foot traffic could be considered a proxy for demand, or another variable which together with other variables indicates demand. A large number of people in the area might, e.g., trigger an increase in delivery of products.

In addition to or in lieu of a sensor, the vending machine may include an input device which allows a temperature (or other data) to be input, e.g., by an operator of the vending machine. Such an input device may comprise, e.g., a keypad or another know device which allows numeric input to be received by the vending machine.

Such an input device may be located such that only an authorized operator can access the input device. For example, the input device may be located inside a cabinet of the vending machine and accessible only upon unlocking the cabinet using a key. Alternatively or additionally, the input device may be located such that anyone can interact with the input device, but authorization is required to have the input entered or accepted. For example, the input device may require a valid authorization code to be entered, or a proper key to be inserted, before a temperature is accepted via the input device.

Vending machine 100 may also include one or more of several payment processing mechanisms which enable, e.g., receiving payment and/or dispensing change. Payment processing mechanisms include coin acceptor 112, bill validator 114, magnetic stripe reader 116 (or other card reader) and change dispenser 118. Magnetic stripe reader 116 is a conventional reader for reading data on the magnetic stripe of a credit or debit card, and it may cooperate with conventional remote point-of-sale credit card processing equipment (not shown) to validate credit based purchases through a conventional credit authorization network. Suitable card-based transaction processing systems and methods are available from USA Technologies, Inc., of Malvern, Pa.

Coin acceptor 112, bill validator 114 and change dispenser 118 communicate with currency storage apparatus 120 and may include conventional devices such as Mars models AE-2400, MC5000, TRC200 or CoinCo model 9300-L. Coin acceptor 112 and bill validator 114 can receive and validate currency that is stored by currency storage apparatus 120. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein. The change dispenser facilitates or activates the return of coinage to the customer where appropriate.

In one embodiment, a payment processing mechanism includes a device that is configured to receive payment authorization and product selection commands through a wireless device communication network, directly or indirectly, from a customer device (e.g. a cellular telephone). In such an embodiment, a payment processing mechanism may comprise a cellular transceiver operatively connected to a processor, as described herein. Systems and methods allowing for the selection of and payment for vending machine articles through cellular telephones are provided by USA Technologies, Inc. Further, in such an embodiment, a customer cellular telephone may serve as an input/output device, as described herein.

The Vertical Drop Columns in the machine use an Auger that rotates counter-clockwise to drop the drink into the Product Bin. The columns employ the use of a combination of metal Shims to hold the front-most product from dropping during the first vend. On the second vend, the Auger rotates counter-clockwise further and allows the front product to vend. A third rotation occurs only if the column is set for cans. The combination of Auger, Shim(s) and Rear Spacer position allow for different sizes and types of product packaging.

To control the rotation of the Auger, there is a Home Switch located behind each vertical drop column motor. There are Cams installed on the front of each auger, one for bottles and one for cans. The lobes on these cams determine the stopping point of the Auger for each vend.

FIG. 1C is an illustration of the factory default settings for each column. Be aware that each column has been set for specific brands of products in the size listed. In one embodiment, the columns are marked for “CANS” and “BOTTLES” with labels on the interior beverage door. To deposit healthy containers into the slots:

1.) For most bottles, place top of the first bottle against the front of the column, with the Sold Out Switch is depressed. Place the second bottle to the rear of the column, facing the bottom of the bottle with the bottom of the first bottle. Load 12 oz. cans bottom to bottom in the first two positions, then top to top in the back position. Load 16 oz. cans bottom to top. 20 oz. Gatorade bottles are loaded bottom to top.

2.) To adjust the rear spacer, grasp firmly and lift, freeing the spacer from the slots in the column sides. Move the rear spacer to the closest slot to the back of the bottle or can placed in the rear of the column. Insert the bottom left corner first. The gap between the rear spacer and the rear bottle or can must be less than ½ A inch. The slots are in ½ inch increments to let you adjust for many sizes of products. Lower the rear spacer into the new position, making sure the spacer is straight vertically.

3.) Finish loading to the top of the column, making sure the items are perfectly horizontal and not tilted or skewed in the column.

By adjusting the Shims and/or changing the cams any column can be converted to cans or bottles. In the traditional beverage world, drink manufacturers such as Coke, Pepsi and Gatorade ensure any new drink they produce meets standard agreed upon criteria in shape and size. Meeting these standards ensure the drink will vend properly in vending machines. They differentiate the look of their product through the colors used in labeling but they do not change the size or shape of the cans or bottles.

The adjustable shim that comes in each lane of the beverage section will allow the user to vend a majority of healthy beverages—however, not all beverages can be vended. For example, the user should not attempt to vend drinks that are in square or octagonal shaped bottles or cans. The user should also be very careful with any product greater than 20 oz. and with tall, thin cans or bottles.

FIG. 1D shows an exemplary container for healthy food such as vegetable or snacks, among others. The container of FIG. 1D is specifically sized to fit the dimensions of a standard can for ease of vending through standard machines. In the embodiment of FIG. 1D, the container is a jar with a neck portion and a body portion. One suitable container is a 16-oz wide-mouth glass jar from Soda Lime Glass. The jar has a capacity of 16.47 oz (overflow), with a weight of 7.52 oz, and is recycleable.

| GENERAL PROPERTIES | CLEAR GLASS |
|---|---|
| Clarity | Transparent |
| Moisture Barrier | Excellent |
| Oxygen Barrier | Excellent |
| Resistance to Acids | Fair to Very Good |
| Resistance to Grease and Oil | Excellent |
| Temperature at which Distortion Occurs | 850° F. |
| Rigidity (Stiffness) | Excellent |
| Resistance to Impact | Fair |
| Resistance to Heat | Excellent |
| Resistance to Cold | Excellent |
| Resistance to Sunlight | Fair |

The dimensions of the can vary according to country. Various standard capacities are used throughout the world.

Australia: In Australia the standard can size for alcoholic and soft drinks is 375 ml. Energy drinks are commonly served in 250 ml and 500 ml sizes.

Brazil: In Brazil the standard can size is 355 ml.

New Zealand: In New Zealand the standard can size is 355 ml, although Coca-Cola Amatil changed it's canned beverages to 330 ml in 2017.[5]

China: In China the most common size is 330 ml. Can dimensions may be cited in metric or imperial units. Imperial dimensions for canmaking are written as inches+sixteenths of an inch (e.g. “202”=2 inches+2 sixteenths).[6]

Europe: In Europe the standard can used to be 330 ml but since the 1990s the 250 ml size has slowly become about just as common. In European countries the 500 ml can size is second standard. It's often used for beer, cider and energy drinks.

In the UK 440 ml is commonly used for lager and cider.

In Austria energy drinks are usually sold in sizes 200 to 300 ml. In 2014 for beverage cans in general, already much more aluminium is used than steel. There are even steel cans with alu-lids and vice versa.

Hong Kong: In Hong Kong most cans are 330 ml.

India: In India standard cans are 330 ml.

Japan: In Japan the most common sizes are 350 ml and 500 ml. Larger and smaller cans are also sold.

South Korea: In South Korea 250 ml cans are the most common for soft drinks. However, when accompanying take out food (such as pizza or chicken), a short 245 ml can is standard. Recently, some 355 ml cans which are similar to North American cans are increasingly available, but limited mostly to Coca-Cola and Dr Pepper. Finally, beer cans also come in 500 ml forms.

Malaysia and Singapore: In both Malaysia and Singapore, the most commonly found cans are 300 ml for non-carbonated drinks and 325 ml for carbonated drinks. Larger 330 ml/350 ml cans are limited to imported drinks where it would usually cost a lot more than local ones.

Pakistan: In Pakistan the most common sizes are 250 ml and 330 ml. 200 ml cans are also sold.

North America: In North America, the standard can size is 12 US fl oz or 355 ml. The US standard can is 4.83 inches high, 2.13 inches in diameter at the lid, and 2.60 inches in diameter at the widest point of the body. Also available are 16 oz cans known as pounders, and 24 oz cans or larger are referred to as tall boys.

In Canada, the standard size was previously 10 Imperial fluid ounces (284 ml), later redefined and labeled as 280 ml in around 1980. This size was commonly used with steel beverage cans in the 1970s and early 1980s. However, the US standard 355 ml can size was standardized in the 1980s and 1990s, upon the conversion from steel to aluminium. Some beverage such as Nestea are sold in 341 ml cans. In Quebec by the year 2015, a new standard for carbonated drink have been added as many important grocery store now only sell 6-packs (with plastic holds) with 222 ml cans instead of the original 341 ml (for the same price) and that from every major carbonated drinks. Many convenience stores began selling “slim cans” with a 310 ml capacity as of late 2015

South Africa: South African standard cans are 330 ml (reduced in the early 2000s from the up-until-then ubiquitous 340 ml) and the promotional size is 440 ml. There is also the 500 ml can. A smaller 200 ml can is used for “mixers” such as tonic or soda water. It has a smaller diameter than the other cans.

Middle East: In the Middle East standard cans are 330 ml.

The container of FIG. 1D can include a wireless tag, which with an RFID system allows a reader/writer to read information stored in a wireless tag. In one embodiment, the reader/writer is configured to transmit roughly 1 W signals using a wireless line of the UHF band (of 860-960 MHz), whereas the wireless tag is configured to receive the signals and send response signals back to the reader/writer. The wireless frequency band, used in Japan, ranges from 952 MHz to 954 MHz. Read range is herein roughly 3-10 m, although depending on: the antenna gain of a wireless tag; the operating voltage of a wireless IC chip; the antenna gain of a reader/writer; and the surrounding environment. The wireless tag includes an antenna and a wireless IC chip (of a square type having roughly 0.5 mm sides) to be connected to a power supply contact of the antenna. In the wireless tag, an antenna pattern is formed on a translucent film sheet by means of printing, etching and the like. The wireless IC chip is connected to the power supply contact of the antenna although no special matching circuit is mounted on the power supply contact. A wireless IC chip (hereinafter simply referred to as “an IC chip”) is allowed to be equivalently expressed with a parallel circuit having an internal resistor Rc (of e.g., 1700Ω) and a capacitance Cc (of e.g., 1.0 pF). Further, an antenna is allowed to be equivalently expressed with a parallel circuit having a radial resistor Ra (of e.g., 20000) and an inductance La (of e.g., 30 nH). When the IC chip and the antenna are connected in parallel, resonance occurs between the capacitance Cc and the inductance La and impedances are accordingly matched at a desired resonance frequency fo (of e.g., 953 MHz). Accordingly, electric power received by the antenna is maximally provided to the IC chip. When wireless tags are attached onto nonconductive members (or nonmetal members) such as cardboard members or plastic members, the dipole antennas are often used as the wireless-tag antennas. A single dipole antenna may include a meander-shaped dipole section, and the entire length thereof may be roughly 140 mm corresponding to λ/2. In this case, a single wireless tag may have a size of 10 cm by 2 cm.

Referring now to FIGS. 2 and 3, coin acceptor 112, bill validator 114, magnetic stripe reader 116 and change dispenser 118 communicate with, and are controlled by, processing module 144. Processing module 144 may include network communication port 142 for permitting communication with (i) the previously mentioned components of vending machine 100, a central controller via a network (not shown), and/or (iii) other components or devices. The network communication port 142 may comprise a modem (e.g. a cellular modem or otherwise), a wireless transmitter or transponder (e.g. an infrared transmitter/receiver, a radio transmitter/receiver).

In addition to the elements previously mentioned, processing module 144 may include a central processing unit 126 (also referred to as a “CPU” or “processor”) connected to communication port 142. CPU 126, which may comprise one or more Intel® Pentium® or Centrino™ processors, communicates with random access memory (RAM) 128, read only memory (ROM) 130, clock 132. CPU 126 also communicates with at least one item dispenser 122, at least one price display 124 and storage device 134. Price display 124 may be any display device, preferably a digital display, employing conventional technology such as a light emitting diode (“LED”) display or a liquid crystal display (“LCD”).

The CPU 126 and the storage device 134 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the vending machine may comprise one or more computers (or processors) that are connected to a remote server computer operative to maintain databases, where the storage device 134 comprises a combination of a remote server computer and associated databases.

Vending machine 100 may includes dispensers, such as the twelve item dispensers 122 and twelve price displays 124, one item dispenser and display corresponding to each product offered for sale by vending machine 100. Any number of item dispensers and any number of price displays may be used, and the number of item dispensers need not equal the number of price displays.

Product inventory storage and item dispensing functions of a vending machine configured in accordance with a snack machine embodiment of the present invention may include one or more of: (i) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit.

In some embodiments, a vending machine may be housed in a casing of the model 129 SnackShop manufactured by Automatic Products™. In such embodiments, three removable shelves may be employed, together providing for thirty product rows and an inventory capacity of between 185 to 522 commonly vended snack products.

Inventory storage and item dispensing mechanism(s) 122 may comprise one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known in the art.

As in many conventional vending machines, item dispenser 122 may be activated by CPU 126 after a customer has purchased item 136, causing item 136 to be transferred to receptacle 140. A customer has access to a purchased item in receptacle 140 via door 138. Purchased item 136 can then be removed by a customer from receptacle 140 through door 138.

As shown in FIGS. 1 and 2, each item dispenser 122 has a corresponding price display 124 that displays information pertaining to item 136 dispensed by item dispenser 122. Typically, price display 124 will display the price of item 136 as determined according to the steps of the present invention. Although vending machine 100, as illustrated, includes a plurality of item dispensers 122 and a plurality of displays 124, this is only one possible embodiment of the many types of vending machines that could employ the present invention. Selecting an appropriate conventional item dispensing mechanism, a single item dispenser 122 could be used to dispense the plurality of items 136. Likewise, a single price display 124 could be used to communicate prices and other information of the plurality of products.

The container of FIG. 1D is preferably vacuumed to remove air inside the container and sealed. Vacuum sealing appliances are used to commercially to evacuate air from various containers such as plastic bags, reusable rigid plastic containers, or mason jars. These containers are often used for storing food. Vacuum sealing food packaging provides many benefits with a particular advantage of preserving the freshness and nutrients of food for a longer period of time than if food is stored while exposed to ambient air.

One embodiment operates by receiving the jar of FIG. 1D, isolating the interior of the jar from ambient air, and drawing air from the interior of the jar before sealing it. The system can use a nozzle to evacuate air from jars, while a sealing door operated in conjunction with a heat-sealer to seal the jar closed.

As shown in FIG. 3, an exemplary process to vacuum seal the product and seal the product in the jar is as follows:
inserting a product into a container fitting dimensions of vending machine cans (200)
removing air from the container and sealing the container (202)
placing the container in a vertical drop column sized for the cans (204)
delivering the container with the product into a receptacle (206) and optionally, releasing the container after checking tag to confirm expiration date/freshness (208)

In one aspect, a system for evacuating containers that conform to soda/drink vending machine is provided comprising a base housing and a recess defined within the base housing. A vacuum inlet port is within the recess and is in communication with a vacuum source located within the base housing. An inner door is hinged to the base housing and sized to cover the recess when in a closed position. An outer door having a heat sealing means mounted thereon is hinged to close over the inner door. A vacuum nozzle extends at least partially between the inner and outer doors and is in communication with the recess. The inner and outer doors cooperate to retain a flexible container therebetween and around the nozzle so that the nozzle is positioned for fluid communication with an inside of the container.

In another aspect, an apparatus for sealing a plastic bag is provided. The apparatus comprises a base housing, a vacuum source mounted within the housing and a removable drip pan resting in the base and in communication with the vacuum source. A nozzle extends at least partially over the pan in communication with the vacuum source. A pair of doors is hingeably mounted to the base housing surrounding the nozzle for engaging the bag when an opening of the bag is positioned around the nozzle. A heating element mounted on one of the doors for heat-sealing the bag.

In yet another aspect, an evacuable lid and container combination is provided for use with the appliance and/or system. The lid and container combination comprises a container having an open mouth and a lid adapted to cover the open mouth to define an enclosable chamber. The lid defines a central recess, and at least one central recess passageway located within the central recess able to sustain an air flow from an upper side of the canister lid to a lower side of the canister lid. A piston assembly is mounted for reciprocal movement within the central recess, with at least one piston passageway defined within the piston assembly capable of sustaining air flow through the piston assembly. A piston pipe is configured to retain the piston within the central recess, and a knob is configured to rotate the piston assembly via the piston pipe to align the at least one central recess passageway and the at least one piston passageway.

Flash Freezing Vegetables And Fruits can be vended by the machines as well. For storing vegetables for 2 years or more, one method includes flash freezing them before following up with the vacuum sealing process. Contrary to normal process of freezing, all the juices and nutrients are locked inside the food in the form of minute ice crystals with flash freezing. So, upon rehydration, they taste very much like the original product. Flash freezing or drying is carried out in laboratories using expensive equipment and super cooled gases. In one embodiment, the prepared bits of veggies or fruits are spread evenly on a large cookie sheet to form a single layer where none of the pieces are sticking together. This tray then goes into the freezer and left in there for a certain period of time. An even better approach is to cover the fruit or veggie bits with ice and then put in the freezer, which further evens out the freezing process. If you are unsure about the progress, then pick out a piece from the tray and thaw it to check if it re-hydrates with the right consistency. Vacuum sealed, flash dried fruits and veggies can last for several years without losing flavor or nutrients. When the customers are ready to reuse them, simply remove the constituents from the bag, and reheat them in a microwave or steamer with some water. They will taste much like they did when they were freshly plucked.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed.

The present invention can be configured to work in a network environment including a computer that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. Each of the vending machines may comprise computers, such as those based on the Intel® Pentium® or Centrino™ processor, that are adapted to communicate with the computer. Any number and type of machines may be in communication with the computer.

Communication between the vending machines and the computer, and among the vending machines, may be direct or indirect, such as over the Internet through a Web site maintained by computer on a remote server or over an on-line data network including commercial on-line service providers, bulletin board systems and the like. In yet other embodiments, the vending machines may communicate with one another and/or the computer over RF, cable TV, satellite links and the like.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that vending machines and/or computers in communication with each other need not be continually transmitting to each other. On the contrary, such vending machines and/or computers need only transmit to each other as necessary or desirable, and may actually refrain from exchanging data most of the time. For example, a vending machine in communication with another machine via the Internet may not transmit data to the other machine for weeks at a time.

In an embodiment, a server computer may not be necessary or desirable. For example, the present invention may, in one or more embodiments, be practiced on a stand-alone vending machine and/or a vending machine in communication only with one or more other vending machines. In such an embodiment, any functions described as performed by the server computer or data described as stored on the server computer may instead be performed by or stored on one or more vending machines.

In other embodiments, a vending machine may be in communication with a remote computer, such as a server, that provides the vending machine with and/or receives from the vending machine, e.g., all or some of the data described herein. Thus, in certain embodiments, the server may comprise certain elements or portions of certain elements such as a data storage device/memory.

In such an embodiment, the remote computer could be accessible, directly or indirectly, via a second computer (communicating over the Internet or other network) by a customer or operator. Accordingly, a customer or operator of the second computer could communicate with the remote computer via a Web browser. The second computer could, e.g., receive from the remote computer messages described herein as being output by the vending machine, and/or transmit to the remote computer input described herein as being provided to the vending machine. Similarly, various data described herein as received through an input device of a vending machine may be received through a Web browser communicating with a remote server, which in turn communicates with the vending machine. Thus, an operator of the vending machine may have remote polling and reporting capabilities, may be able to transmit new business rules to the vending machine, and the like.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method for dispensing product, comprising
placing substantially healthy edible food inside a container;
sealing the container;
inserting the container fitting dimensions of vending machine cans;
placing the container in a vertical drop column sized for the cans; and
upon order, delivering the container with the product into a receptacle.

2. The method of claim 1, further comprising vacuuming air from the container.

3. The method of claim 1, comprising placing a healthy food, vegetable or fruit into the container.

4. The method of claim 1, comprising freezing the product and a jar.

5. The method of claim 1, comprising refrigerating the product and a jar.

6. The method of claim 1, comprising tracking an expiration date to ensure freshness.

7. The method of claim 1, wherein each container comprises an IOT object with a communication device communicating with a server to track freshness or expiration of product.

8. The method of claim 1, comprising refrigerating the product.

9. The method of claim 1, comprising storing the container in a plurality of product trays with movable coils and dispensing the product by moving the coils to drop the container into the vertical drop column.

10. The method of claim 1, wherein the container comprises a can, a bottle, a bag, or a jar.

11. A system for dispensing product, comprising:
a machine to place substantially healthy food inside a container, wherein the container conforms to dimensions of standard vending machine cans;
a sealer for removing air from the container and sealing the container; and
a vending machine to move the container from storage into in a vertical drop column sized for a standard sized can, wherein upon receiving order, the vending machine delivers the container with the product into a receptacle.

12. The system of claim 11, wherein the container comprises an open mouth jar, further comprising vacuuming air from the jar and sealing the jar.

13. The system of claim 11, wherein the product comprises vegetable or fruit.

14. The system of claim 11, comprising freezing the product and a jar.

15. The system of claim 11, comprising a refrigerator to cool the product in the container.

16. The system of claim 11, comprising a sensor for tracking an expiration date to ensure freshness.

17. The system of claim 11, wherein each container comprises an IOT object with a communication device communicating with a server to track freshness or expiration of product.

18. The system of claim 11, wherein the container is stored in a plurality of product trays with movable coils and wherein the vending machine dispenses the product by moving the coils to drop the container into the vertical drop column.

19. The system of claim 11, wherein the container comprises a can, a bottle, a bag, or a jar.

20. A container, comprising:
an open end to receive a substantially edible solid product therein;
a mouth that is vacuum sealed after receipt of the product;
a body to store a product wherein the body conforms to dimensions of standard
vending machine cans, wherein the container in a vertical drop column sized for the cans; and
a tag coupled to the body to indicate freshness, wherein the tag is read prior to dispensing the container to a customer.
